(19) United States
(12) Patent Application Publication
(10) Pub. No.: US 2016/0048311 A1
(43) Pub. Date: Feb. 18, 2016

(54) AUGMENTED REALITY CONTEXT SENSITIVE CONTROL SYSTEM

(71) Applicant: Disney Enterprises, Inc., Burbank, CA (US)

(72) Inventors: Christopher Purvis, Estacada, OR (US); Jonathan Ackley, Glendale, CA (US)

(73) Assignee: DISNEY ENTERPRISES, INC., Burbank, CA (US)

(21) Appl. No.: 14/460,317

(22) Filed: Aug. 14, 2014

(51) Int. Cl. G06F 3/0484; G06F 3/0482

(52) U.S. Cl. CPC G06F 3/04847; G06F 3/0482; G06F 3/04842

(57) ABSTRACT

A process and apparatus provide an adaptable user interface. An image of a device is captured. Further, the process and apparatus identify a device identifier of the device based upon the image. In addition, the process and apparatus retrieve a control interface based upon the device identifier. The control interface includes a plurality of buttons that control operation of the device. The control interface is displayed. Alternatively, a process and apparatus provide a uniform user interface and have adaptable communications protocols. The process and apparatus displays a uniform control interface for operation with a plurality of devices. The control interface includes a plurality of buttons that controls operation of the plurality of devices. Further, an image of a device is captured. In addition, the process and apparatus identify a device identifier of the device based upon the image. A communications protocol is also retrieved based upon the device identifier.

### BACKGROUND

1. Field

This disclosure generally relates to the field of remote control configurations. More particularly, the disclosure relates to user interfaces for remote control configurations.

2. General Background

The operation of multiple devices often requires multiple remote controls. For example, different remote controls may be needed to operate a television and a DVD player. The button arrangements on the different remote controls are often different. Accordingly, users typically find that trying to operate various remote controls for different devices is quite cumbersome.

Some configurations allow for the same remote control to be used to operate different devices through modal operations. The user has to select a particular mode to operate a particular device. Such configurations require the user to switch modes based upon the particular device being used. If the user does not switch to a correct mode, that user may press an incorrect button that appears to be correct. For instance, a play button may provide play functionality in a first mode rather than a second mode. The user has to remember which buttons are associated with particular functionality in different modes. Accordingly, configurations that use a single remote control device to operate multiple devices are often too cumbersome for users.

Therefore, current remote control devices do not provide adequate ease of use for the operation of multiple devices. A remote control device that provides an adaptable user interface that adapts to a particular device being used is needed. Further, a remote control device that provides a uniform user interface and has adaptable communications protocols is needed.

### SUMMARY

A process and apparatus provide an adaptable user interface. The process and apparatus capture an image of a device. Further, the process and apparatus identify a device identifier of the device based upon the image. In addition, the process and apparatus retrieve a control interface based upon the device identifier. The control interface includes a plurality of buttons that control operation of the device. The process and apparatus display the control interface at a control device that is distinct from the device.

Further, a process and apparatus provide a uniform user interface and have adaptable communications protocols. The process and apparatus display a uniform control interface at a control device for operation with a plurality of devices. The control interface includes a plurality of buttons that controls operation of the plurality of devices. Further, the process and apparatus capture an image of a device. In addition, the process and apparatus identify a device identifier of the device based upon the image. The process and apparatus also retrieve a communications protocol based upon the device identifier.

In addition, a process that provides a uniform user interface that is customizable and has adaptable communications protocols is provided. The process displays a uniform control interface at a control device for operation with a plurality of devices. The control interface includes a plurality of buttons that controls operation of the plurality of devices. Further, the process captures an image of a device. In addition, the process identifies a device identifier of the device based upon the image. The process also retrieves a communications protocol based upon the device identifier. Further, the process retrieves a customized control interface based upon the device identifier. In addition, the process customizes the uniform control interface according to the customized control interface. The process also displays the customized control interface.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an augmented reality context sensitive control system.

FIG. 2 illustrates an example of the control device as a tablet device.

FIG. 3 illustrates the internal components of the control device.

FIG. 4 illustrates an example of an interface that is customized for interaction with the television illustrated in FIG. 1.

FIG. 5 illustrates an example of a uniform interface that is used by the control device for interacting with multiple devices.

FIG. 6 illustrates a process that uses interface customization and communication protocol customization.

### DETAILED DESCRIPTION

An augmented reality context sensitive control system provides for control of a plurality of electronic devices. The augmented reality context sensitive control system allows a user to use a control device to control the plurality of electronic devices with ease of use by changing a control interface depending upon the particular device that is intended to be operated by the user with the control interface.

Alternatively, the augmented reality context sensitive control system uses the same control interface to control the plurality of electronic devices. The augmented reality context sensitive control system changes the particular communication protocols used between the control device and the device that is operated based upon the particular device being operated. Accordingly, the same buttons may be used to perform the same or similar functionality on different devices.

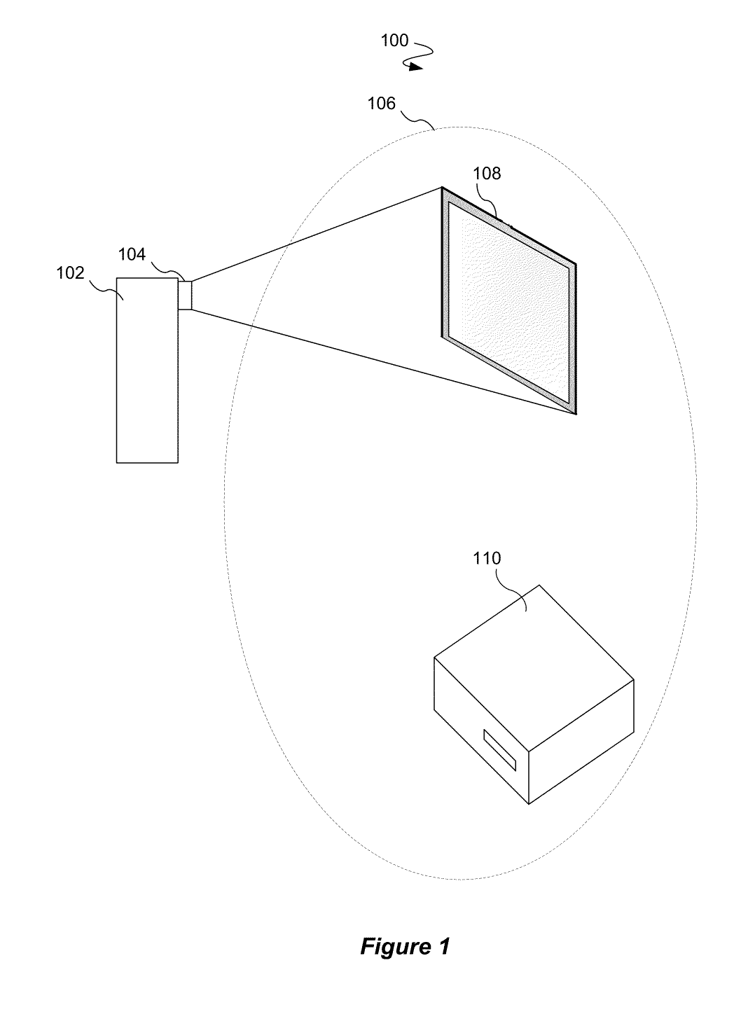

FIG. 1 illustrates an augmented reality context sensitive control system 100. The augmented reality context sensitive control system 100 includes a control device 102 that has an image capture device 104, e.g., a camera. Examples of the control device 102 include devices with cameras such as smartphones, tablet devices, etc. The control device 102 operates a plurality of devices 106. As examples, the plurality of devices 106 may include a television 108 and a DVD player 110. A variety of other devices such as coffee makers, clocks, etc. may be controlled by the plurality of devices 106. The control device 102 is used to power a device 106 on or off, change device 106 parameters, change channels, etc. The control device 102 may communicate with a device 106 through a wired connection or a wireless connection, e.g., infrared (“IR”), radio frequency (“RF”), etc.

In one implementation, a user that wants to use the control device 102 to control the multiple devices 106 obtains different control interfaces for each device 106 through the context sensitive control system 100. The image capture device 104 captures image data for each of the plurality of devices 106. The control device 102 or a device in operable communication with the control device 102 uses object recognition code to identify the object in the captured image. The corresponding control interface for each device 106 is then retrieved. A user then selects the interface for a corresponding device 106 to control operation of that device 106. The user may store the retrieved interfaces on the control device 102 for subsequent operation of the devices 106.

For instance, a user with a control device 102 obtains control interfaces for new devices 106, devices 106 that are temporarily used in a location to which the user is not accustomed, etc. The user may use a mobile computing device such as a table device at different locations to obtain control interfaces for different devices 106 present at those locations. Therefore, the user can quickly obtain and use control interfaces for controlling devices 106.

In another implementation, a user that wants to use the control device 102 to control the multiple devices 106 obtains different communication protocols for each device 106 through the context sensitive control system 100. Rather than using different control interfaces for different devices 106, the user uses the same control interface to control each of the plurality of devices 106. For instance, the same control interface has a play button that is used to provide a play command to both the television 108 and the DVD player 110. Although the control interface appears to have the same play button, the control device 102 uses different communication protocols to communicate the play command to the television 108 and the DVD player 110. Therefore, the control device 102 captures images of the devices 106 so that the object recognition software identifies the devices 106 for the determination of corresponding communication protocols.

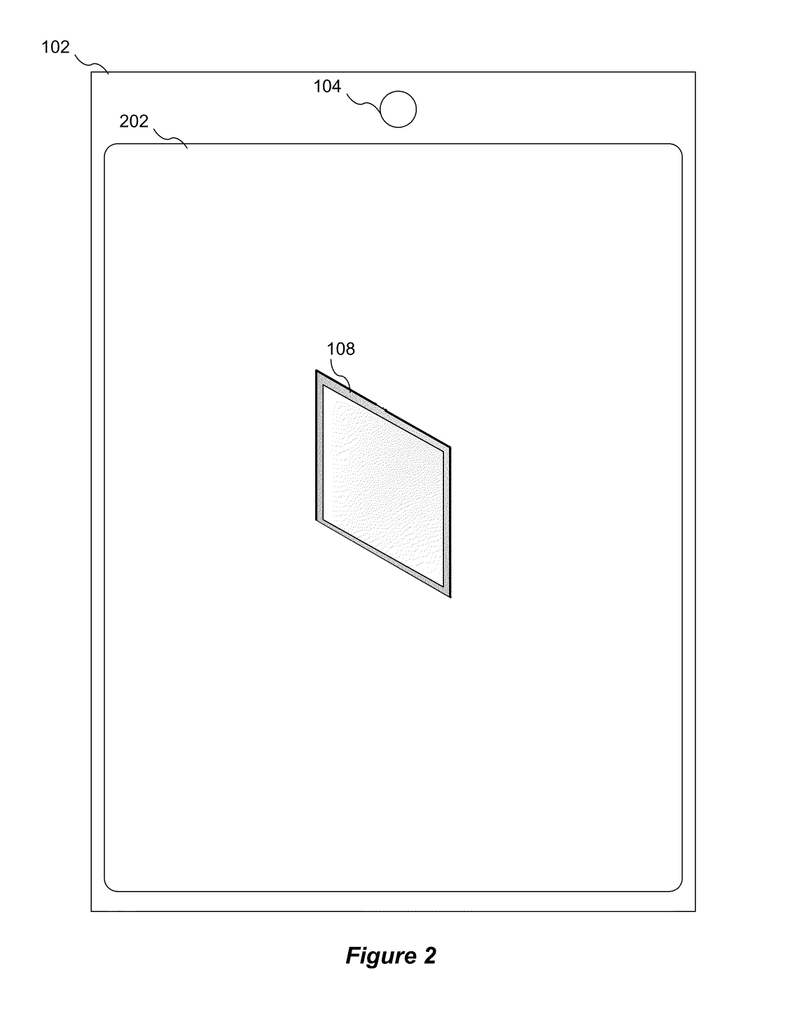

FIG. 2 illustrates an example of the control device 102 as a tablet device. The control device 102 has a display 202 that is used to display images captured by the image capture device 104, e.g., a camera built into the control device 102. A user positions the control device 102 so that an image of a device 106 such as the television 108 is captured. The image can be obtained from a photograph taken by the user with the control device 102 or a video stream generated from the control device 102 being positioned in front of the device 106. The control device 102 or a device in operable communication with the control device 102 uses object recognition code, e.g., optical object recognition code, audio hypersonic object recognition code, etc., to identify the object in the focus area of the photograph or video stream, e.g., the television 108. For example, various device identifiers are obtained from a screen bitmap of the captured image. Examples of device identifiers include manufacturer names, model numbers, bar codes, images of devices 106, 3D meshes of devices 106, shapes of devices 106, button assortments, etc. The object recognition code is used to determine a possible match of a device 106 with those corresponding features. After a match is determined, the control device 102 obtains a control interface corresponding to the matched device 106. The user then uses the control interface corresponding to a particular device, e.g., the television 108, to press interface controls, e.g., buttons, to send signals to the television 108 either wirelessly or through a wired communication. Further, the user easily switches to a control interface for a different device 106, e.g., the DVD player 110 with the same control device 102.

In one implementation, the user uses the control device 102 to obtain different control interfaces for different devices 106 and then operate those different devices with the different control interfaces on the control device 102. In another implementation, the user uses the control device 102 to obtain different communication protocols for different devices 106 and then operate those different devices with the same control interface on the control device 102 based upon the different communication protocols.

In one implementation, the display 202 is used to display captured images of devices 106 and the control interfaces. In another implementation, different displays are used to display captures images of the devices 106 and the control interfaces. Although an image of the television 108 is illustrated as being captured and displayed in the display 202, the image of the television 108 may be captured without display in the display 202.

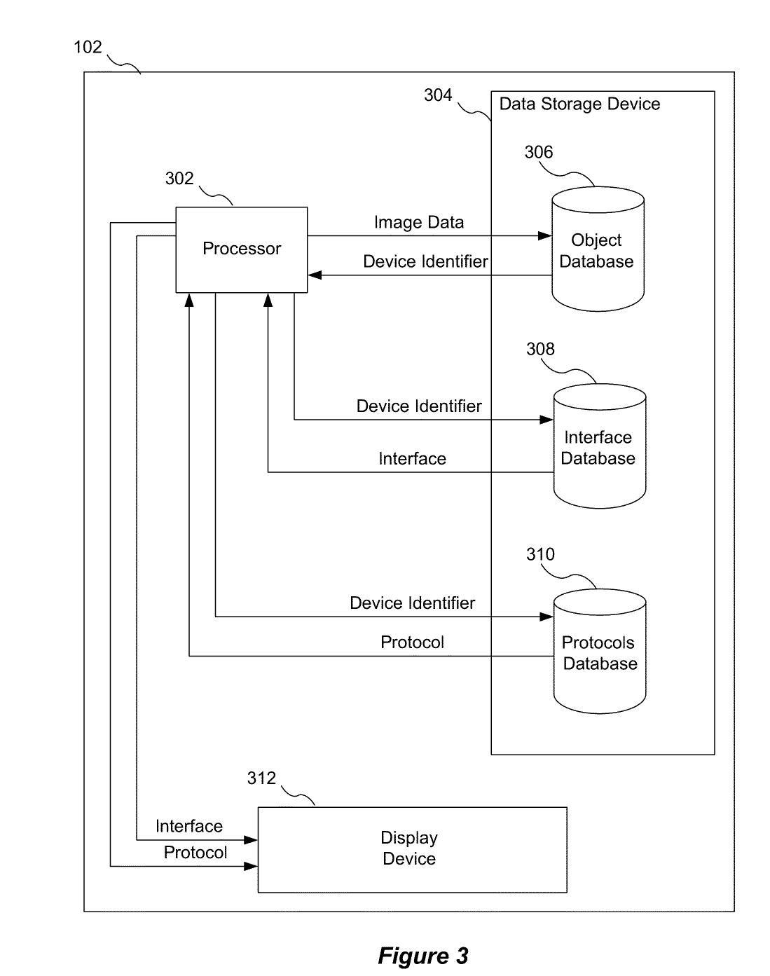

FIG. 3 illustrates the internal components of the control device 102. The control device 102 comprises a processor 302, a data storage device 304, and a display device 312. The processor 302 sends the image data received from the image capture device 104 to an object database 306 that is stored on the data storage device 304. The object database 306 includes images, graphics, 3D models, textures, and any metadata that describes an object. The processor 302 obtains a device identifier from the object database based upon an object recognition process.

In one implementation, the processor 302 sends the device identifier to an interface database 308 that is stored on the data storage device 304. The interface database 308 stores interfaces corresponding to various device identifiers. The processor 302 obtains a particular interface from the interface database 308 that corresponds to the device 106 for which an image has been captured. The processor 302 then sends the retrieved interface to the display device 312 so that the display device 312 renders the interface on the display 202 illustrated in FIG. 2. The user then provides input on an interface that is customized to the particular television 108.

In another implementation, the processor 302 sends the device identifier to a protocols database 310 that is stored on the data storage device 304. The protocols database 310 stores protocols corresponding to various device identifiers. The processor 302 obtains a particular protocol from the protocols database 310 that corresponds to the device 106 for which an image has been captured. The processor 302 then sends the retrieved protocol to the display device 312 so that the display device 312 renders the interface on the display 202 illustrated in FIG. 2 according to the particular communication protocol of the television 108. The user then provides input on the same interface for the devices 106, but that has a customized protocol for communicating with the television 108.

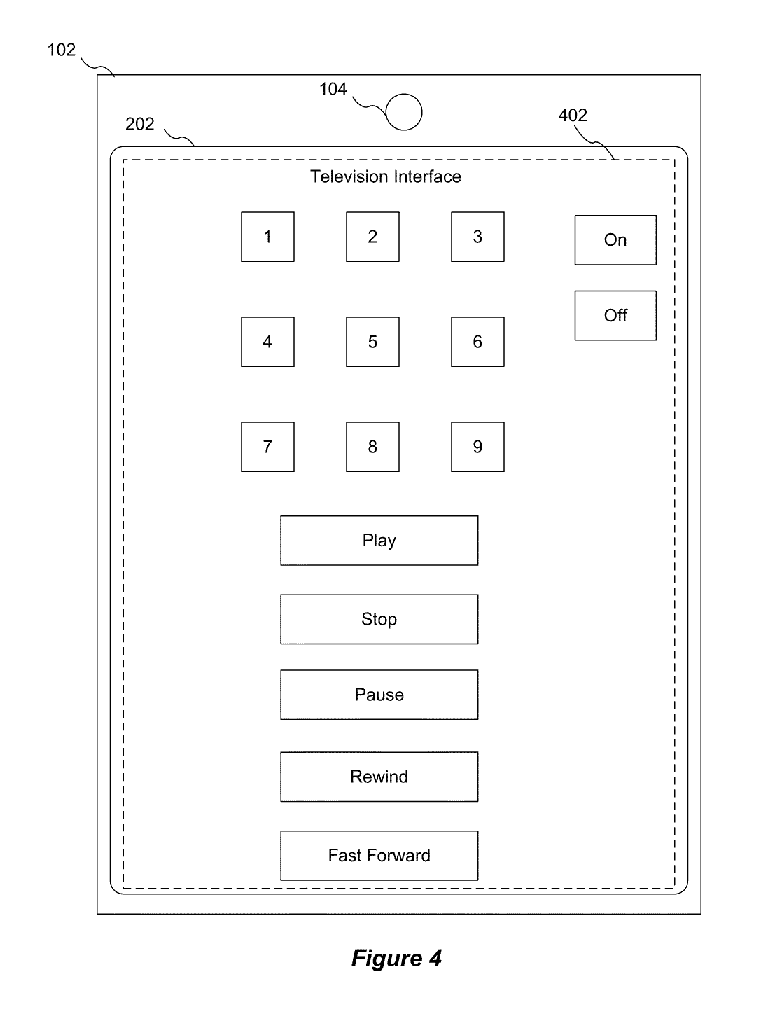

FIG. 4 illustrates an example of an interface 402 that is customized for interaction with the television 108 illustrated in FIG. 1. The interface 402 has a variety of buttons such as numerical input buttons, an on button, an off button, a play button, a stop, button, a pause button, a rewind button, and a fast forward button. After the processor 302 determines the device identifier for the television 108, the processor 302 obtains the interface 402 from the interface database 308 illustrated in FIG. 3. The processor 302 sends the interface 402 to the display device 312 for rendering on the display 202. The user obtains different interfaces for each of the devices 106. The user then uses the same control device 102 to switch amongst different customized interfaces to control multiple devices 106.

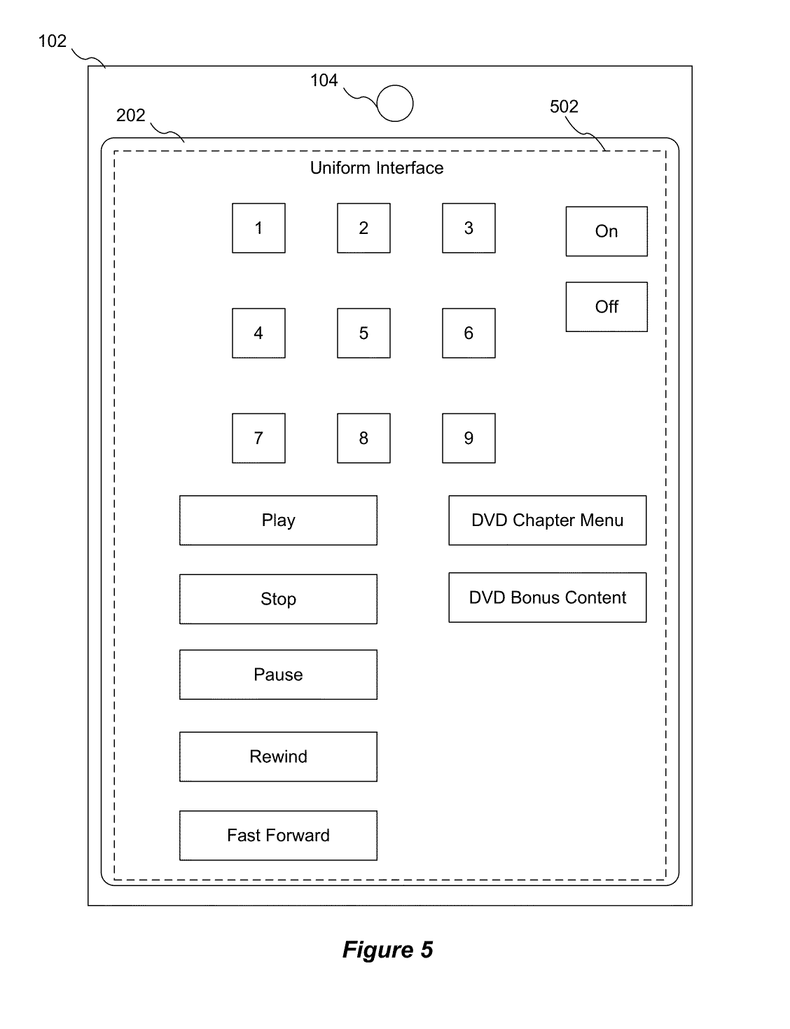

FIG. 5 illustrates an example of a uniform interface 502 that is used by the control device 102 for interacting with multiple devices 106, e.g., the television 108 and the DVD player 110. The interface 502 has a variety of buttons such as numerical input buttons, an on button, an off button, a play button, a stop, button, a pause button, a rewind button, a fast forward button, a DVD chapter menu button, and a DVD bonus content button. The interface 502 is inclusive of buttons for controlling multiple devices 106. For example, the play button is used by the control device 102 to send a play command to the television 108 and send a play command to the DVD player 110. Although the user uses the same uniform interface 502 to operate each of the devices 106, the control device 102 communicates with each of the devices 106 through different communication protocols. For instance, the play command that the control device 102 sends to the television 108 has a different communication protocol than the play command that the control device 102 sends to the DVD player 110. After the processor 302 determines the device identifier for the television 108, the processor 302 obtains the communication protocol for communicating with the television 108 from the protocols database 310 illustrated in FIG. 3. The processor 302 sends the uniform interface 502 to the display device 312 for rendering on the display 202. The processor also sends the communication protocol to the display device 312 so that the display device performs operations based upon the communication protocol. The user uses the same uniform interface 502 to interact with multiple devices 106 without switching amongst different interfaces. Some buttons may operate differently depending upon the device 106 that is being operated, e.g., the rewind button rewinds a different amount of content for the television 108 than the DVD player 110. Further, some buttons may be active for certain devices 106 and inactive for other devices 106. For instance, the DVD chapter menu button and the DVD bonus content menu are active for operation with the DVD player 110 whereas the DVD chapter menu button and the DVD bonus content menu button are inactive for operation with the television 108.

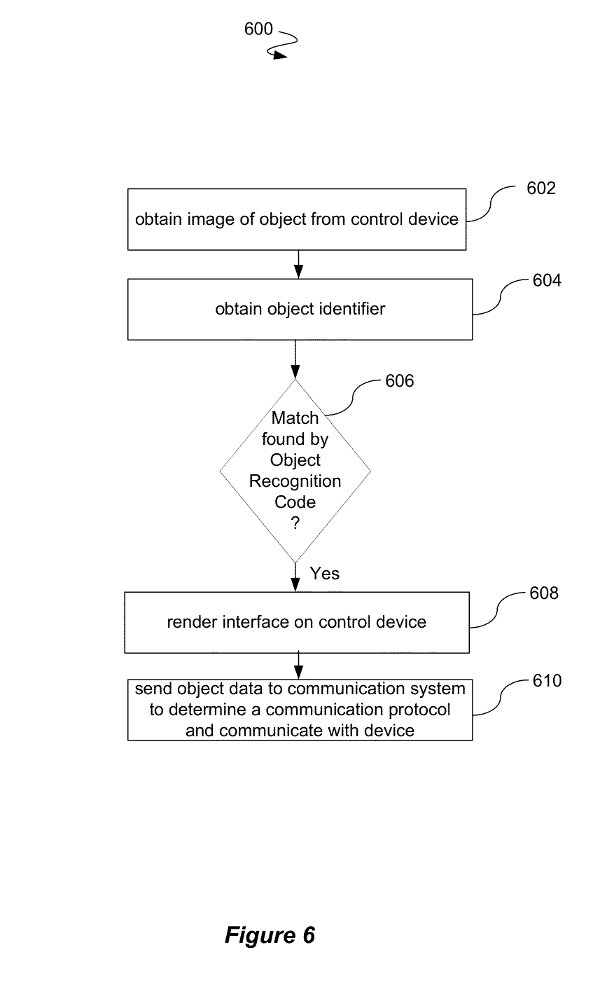

In another implementation, both interface customization and communication protocol customization are used to provide a customized interface to the user. FIG. 6 illustrates a process 600 that uses interface customization and communication protocol customization. At 602, the process 600 obtains an image of an object from the control device 102, e.g., the image capture device 104 illustrated in FIG. 1 captures an image of the television 108. At 604, the process 600 obtains an object identifier, e.g., from the object database 306 illustrated in FIG. 3. At 606, the process 600 determines if a match is found by the object recognition code. The processor 302 illustrated in FIG. 3 uses the object recognition code to find a matching interface based upon the object identifier. If a match is found, the process 600 renders the interface on the control device 102 at 608. As an example, an interface renderer stored on the control device 102 is used to perform the rendering. At 610, the process 600 sends object data to a communication system to determine a communication protocol for the control device 102 to communicate with the device 106. The communication system then provides communication between the control device 102 and the device 106. The communication system may be stored on the control device 102 or operated remotely from the control device 102. The user switches amongst customized interfaces that each has customized communication protocols for communicating with different devices 106.

The processes described herein may be implemented in a general, multi-purpose or special purpose processor. Such a processor will execute instructions, either at the assembly, compiled or machine-level, to perform the processes. Those instructions can be written by one of ordinary skill in the art following the description herein and stored or transmitted on a computer readable medium. The instructions may also be created using source code or a computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. For example, a computer may be a personal computer (“PC”), laptop, smartphone, tablet device, set top box, or the like.

It is understood that the apparatuses, systems, computer program products, and processes described herein may also be applied in other types of apparatuses, systems, computer program products, and processes. Those skilled in the art will appreciate that the various adaptations and modifications of the aspects of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A method comprising:
capturing an image of a device;
identifying a device identifier of the device based upon the image;
retrieving a control interface based upon the device identifier, the control interface including a plurality of buttons that control operation of the device; and
displaying the control interface on a control device, the control device being distinct from the device.

2. The method of claim 1, further comprising receiving an input at the control device based upon a selection of a button from the plurality of buttons and sending a command to the device based upon the input.

3. The method of claim 1, further comprising sending a wireless communication to the device based upon a control interface input.

4. The method of claim 1, further comprising sending an IR communication to the device based upon a control interface input.

5. The method of claim 1, further comprising displaying the control interface according to a display feature that is uniform for the device and an additional device.

6. The method of claim 1, further comprising communicating with the device based upon a network communications protocol that is utilized by the device and an additional device.

7. The method of claim 1, further comprising communicating with the device indirectly through an intermediary device that utilizes a communications protocol to communicate with the additional device.

8. The method of claim 1, further comprising retrieving data from a database based upon the image to identify the device identifier.

9. A method comprising:
displaying a uniform control interface at a control device for operation with a plurality of devices, the control interface including a plurality of buttons that controls operation of the plurality of devices, the control device being distinct from the plurality of devices;
capturing an image of a device from the plurality of devices;
identifying a device identifier of the device based upon the image; and
retrieving a communications protocol based upon the device identifier.

10. The method of claim 9, further comprising receiving an input based upon a selection of a button from the plurality of buttons and sending a command to the device according to the communications protocol based upon the input.

11. The method of claim 9, further comprising sending a wireless communication to the device based upon a control interface input.

12. The method of claim 9, further comprising sending an IR communication to the device based upon a control interface input.

13. The method of claim 9, further comprising displaying the control interface according to a display feature that is uniform for the device and an additional device.

14. The method of claim 9, further comprising associating a plurality of commands for operation of the device with the plurality of buttons based upon the communications protocol.

15. The method of claim 9, wherein the uniform control interface is displayed for communication with the plurality of devices.

16. The method of claim 9, further comprising retrieving data from a database based upon the image to identify the device identifier.

17. A method comprising:
displaying a uniform control interface at a control device for operation with a plurality of devices, the control interface including a plurality of buttons that controls operation of the plurality of devices, the control device being distinct from the plurality of devices;
capturing an image of a device;
identifying a device identifier of the device based upon the image;
retrieving a communications protocol based upon the device identifier.
retrieving a customized control interface based upon the device identifier;
customizing the uniform control interface according to the customized control interface; and
displaying the customized control interface.

18. The method of claim 17, further comprising receiving an input based upon a selection of a button from the plurality of buttons and sending a command to the device based upon the input.

19. The method of claim 17, further comprising sending a wireless communication to the device based upon a control interface input.

20. The method of claim 17, further comprising sending an IR communication to the device based upon a control interface input.

21. The method of claim 17, further comprising displaying the control interface according to a display feature that is uniform for the device and an additional device.

22. The method of claim 17, further comprising retrieving data from a database based upon the image to identify the device identifier.

23. An apparatus comprising:
a processor that captures an image of a device, identifies a device identifier of the device based upon the image, retrieves a control interface based upon the device identifier, and displays the control interface at a control device, the control interface including a plurality of buttons that control operation of the device.

24. An apparatus comprising:
a processor that displays a uniform control interface at a control device for operation with a plurality of devices, captures an image of a device from the plurality of devices, identifies a device identifier of the device based upon the image, and retrieves a communications protocol based upon the device identifier, the control device being distinct from the plurality of devices, the control interface including a plurality of buttons that controls operation of the plurality of devices.
